(19) United States
(12) Patent Application Publication
(10) Pub. No.: US 2019/0385113 A1
(43) Pub. Date: Dec. 19, 2019

(54) TASK BASED TRACKING SYSTEM USING GEOFENCES

(71) Applicant: Alan Dumitras, Douglasville, GA (US)

(72) Inventor: Alan Dumitras, Douglasville, GA (US)

(21) Appl. No.: 16/009,664

(22) Filed: Jun. 15, 2018

(51) Int. Cl. G06Q 10/06; G07C 1/10; H04L 12/66; G01S 1/68

(52) U.S. Cl. CPC G06Q 10/063114; G01S 1/68; H04L 12/66; G07C 1/10

(57) ABSTRACT

A first beacon can detect that a client device entered within a first geofence corresponding to the first beacon. A first task that is to be completed by the client device at the first geofence can be selected. A second beacon can detect that the client device enters within a second geofence corresponding to the second beacon. A second task that is to be completed by the client device at the second geofence can be selected. An action can be executed when the client device is determined to having completed either the first task or the second task.

### BACKGROUND

Large facilities, such as manufacturing facilities, warehouses, distribution centers, hospitals, hotels, resorts, etc., require maintenance staff to conduct various activities at various locations to ensure smooth operation. These tasks are usually tracked on a log sheet by the maintenance personnel performing the tasks. In order to determine if the tasks were completed by the personnel assigned to do them, the sheets need to be manually reviewed to determine if a task was missed.

For some tasks, it may be difficult to determine if they were actually completed. The maintenance personnel may be required to visually inspect various areas in the building. However, a lazy worker may claim the areas are clear without actually visually inspecting the area or equipment. Companies may be paying for services that are not being performed. Having employees monitor the behavior of all contractors when working on premises is not cost effective. It would be beneficial to have a technical solution to ensure that tasks are being completed properly before paying invoices.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a drawing depicting an example scenario in a networked environment according to various example embodiments of the present disclosure.

FIG. 2 is a drawing of the networked environment according to various example embodiments of the present disclosure.

FIG. 3A is a drawing of a networked environment in which tasks are tracked using geofences according to various example embodiments of the present disclosure.

FIG. 3B is a drawing of a networked environment in which tasks are tracked using geofences according to various example embodiments of the present disclosure.

FIG. 4 illustrates an example task list according to various example embodiments of the present disclosure.

FIG. 5 illustrates an example maintenance task report according to various example embodiments of the present disclosure.

FIG. 6 illustrates an example flowchart of certain functionality implemented as portions of a task application executed in a computing environment in the networked environment of FIG. 2 according to various example embodiments of the present disclosure.

FIG. 7 is a schematic block diagram that illustrates an example hardware diagram of a device, such as beacon device or a client device, employed in the networked environment of FIG. 2 according to various example embodiments of the present disclosure.

FIG. 8 is a schematic block diagram that illustrates an example computing environment employed in the networked environment of FIG. 2 according to various example embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Various embodiments of the present disclosure relate to systems and methods for tracking tasks using geofencing. For example, the systems and methods of the present disclosure can track tasks being performed by tracking a duration of time spent at a task location. The duration of time can be determined based on a time a person's client device is located within a geofence that corresponds to the task location. If the duration exceeds the time set for the task, the task can be marked as completed. If, however, the duration does not meet the time set for the task, an action is taken, such as, for example, an alert may be sent to the person or the person's supervisor.

According to the present disclosure, companies can track various tasks performed by contractors and other personnel and ensure that the tasks are being performed as specified before paying invoices. As an example, if a contractor lies in a report saying they visually inspected the pest traps in a warehouse, the company may pay the invoice for work that wasn't completed. However with the disclosed systems and methods, if the client device of the contractor never enters within the geofences near the pest traps, a reliable report can be generated that presents the activity of the contractor within the facility.

According to various embodiments, beacon devices are located across an area to be tracked, such as manufacturing facilities, warehouses, distribution centers, hospitals, hotels, resorts, etc. Each of these beacon devices form a geofence. In various embodiments, multiple beacon devices can be used to form a single geofence. Each of the beacon devices can detect when a client device enters its geofence. The beacon devices can also detect when the client device leaves its geofence. The beacon devices communicate via a gateway to a computing environment. The beacon devices can also communicate to the gateway via sensors that can be placed throughout the facility in a mesh formation and the sensors can communicate with the gateway. The beacon devices can send event information to the computing environment, such as, data corresponding to when a client devices enters a geofence and when the client device leaves the geofence. The computing environment can send configuration commands to the beacon devices and sensors, individually or as a group.

According to various embodiments, the client devices have an identifier that is assigned to them. When a client device enters a geofence corresponding to a beacon device, the beacon device identifies the client device by its identifier and can communicate the identifier of the client device to the computing environmental via the gateway. The computing environment can track the movement of the client device across various geofences based on the events communicated to it by the various beacon devices.

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present disclosure” is not to suggest that all embodiments must include the referenced feature(s).

The embodiments described herein are not limited in application to the details set forth in the following description or illustrated in the drawings. The embodiments disclosed are capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

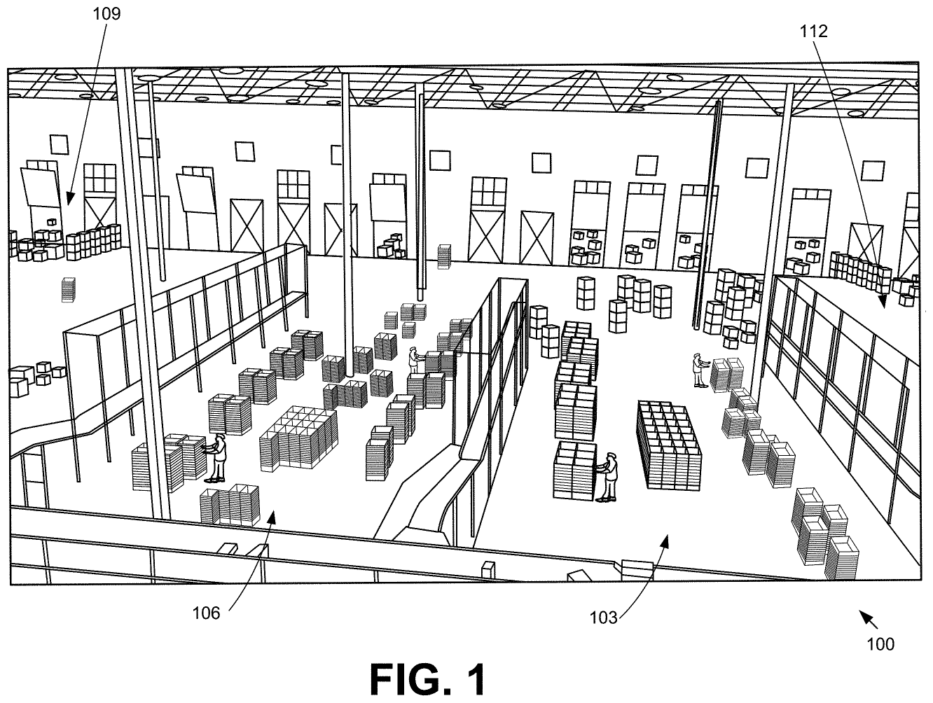

Turning now to the drawings, exemplary embodiments are described in detail. With reference to FIG. 1, shown is a drawing depicting an example scenario in which tasks are tracked using geofences according to various embodiments of the present disclosure. A manufacturing facility 100 can have a number of sub-areas where tasks may be performed. For example, the manufacturing facility 100 may have a production area 103 and a production area 106. Further, the manufacturing facility 100 may have an inventory area 109 and an inventory area 112.

One or more of these areas 103, 106, 109, or 112 can have task areas. These tasks areas can be, for example, an assembly station, a product inspection area, an equipment area, machinery area, or other area. These task areas may require personnel to inspect them at predefined intervals. For example, a company may require a manufacturing maintenance technician to visually inspect the various manufacturing equipment located across the various areas on a daily basis. In some embodiments, various geofences can be set up using beacon devices.

These geofences can be set up to cover an area in proximity to the equipment that needs to be visually inspected. For example, a geofence in proximity may include a distance up to, for example, 3-8 feet from the equipment. When the manufacturing maintenance technician walks within the geofence, a client device carried by the technician can transmit an identifier to the beacon device that is providing the geofence. As an example, the beacon device can send this information to a computing environment. The computing environment can store that the technician entered the geofence at a given time. When the technician leaves the geofence, the beacon device transmits an exit event to the computing environment. The computing environment can log the exit event along with the timestamp.

In a similar way, the technician may walk over to other equipment and enter that equipment's corresponding geofence. The corresponding geofence can be setup by another beacon device. That beacon device can send a similar entry event to the computing environment which logs the event along with the timestamp. When the technician leaves that geofence, the beacon device sends an exit event to the server which the server logs. In this manner, events from other geofences can be collected to track the technician by way of the identifier associated with the client device carried by the technician. The computing environment may calculate time spent in each geofence. The calculated time may be used to determine time spent at each piece of equipment. For example, the time spent in a geofence may be used as the time spent at the equipment within the geofence. In various other embodiments, other bases for calculating the time spent at an equipment may be used.

The computing environment can generate reports on a scheduled basis, such as, for example, hourly, at the end of each shift, daily, weekly, or another time frame. The reports can indicate status of tasks completed. In addition, the computing environment can send alerts, in real-time or near real-time based on, for example, the completion or non-completion of tasks assigned to technicians.

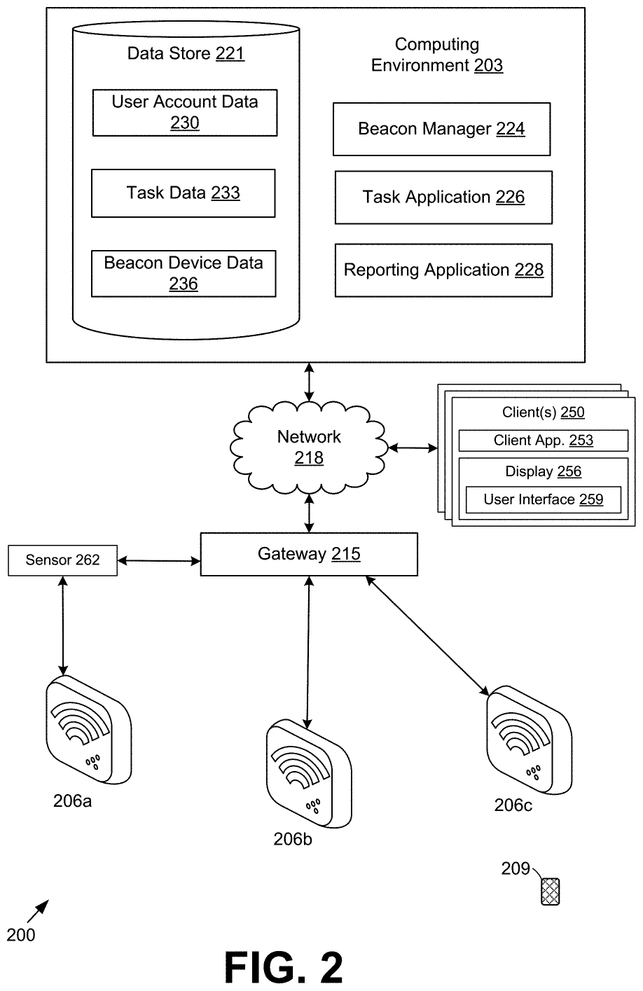

Turning now to FIG. 2, shown is a drawing of a networked environment 200 according to various example embodiments of the present disclosure. The networked environment 200 includes a computing environment 203, one or more beacon devices 206a, 206b, and 206c, one or more sensors 262, gateway 215, and potentially other devices. The gateway 215 is in data communication via a network 218 with the computing environment 203. The network 218 includes, for example, the Internet, intranets, extranets, wide area networks (WANs), local area networks (LANs), wired networks, wireless networks, cable networks, satellite networks, or other suitable networks, etc., or any combination of two or more such networks. In some embodiments, the gateway 215 can be a Software Defined Networking (SDN) device. In various embodiments, the network connection utilizes IPSEC tunneling to communicate data with the computing environment 203 in adherence to the SDWAN (Software defined wide area networking) standard.

The computing environment 203 may include, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may include a hosted computing resource, a grid computing resource, a cloud computing environment, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 221 that is accessible to the computing environment 203. The data store 221 may be representative of a plurality of data stores as can be appreciated. The data stored in the data store 221 for example, is associated with the operation of the various applications and/or functional entities described below.

The components executed on the computing environment 203, for example, include a beacon manager 224, task application 226, a reporting application 228, and other applications, services, processes, systems, engines, or other functionality. The beacon manager 224 is executed to communicate with the beacon devices 206 and others, via the sensors 262 and the gateway 215. The task application 226 is executed to receive events from the beacon devices 206 via the beacon manager 224. The task application 226 can store the events in the data store 221. Additionally, the task application 226 can determine that tasks need to be completed by a particular user account based on the identifier associated with a client device associated with the user account. The task application 226 can track completion of these tasks. The reporting application 228 can generate reports based on the status of tasks, send alerts based on certain criteria being met, generate a dashboard for display by the client device to display reporting regarding various tasks, and perform other actions.

The data stored in the data store 221 includes, for example, user account data 230, task data 233, beacon device data 236, and potentially other data. The user account data 230 can include data about various users and the identifiers of corresponding client devices. The user account data 230 can also include information such as role and policy based task assignments, which can be used to determine the tasks that the user account is required to perform. Additionally, the user account data 230 may be linked to a task list stored in task data 233. Further, the user account data 230 may also contain authentication data that can be used to authenticate a user account via client 250. The authentication data can include user names and passwords, or other authentication credentials. The authentication credentials can be stored in plaintext, encrypted or hashed form. The authentication data can also include other types of data used to authenticate a user of a client device, such as biometric information, single sign-on data, and other data. In various embodiments, Entrust or RSA token may be used to authenticate one or more user accounts, including for administrative rights. Further, Network Access Control (NAC) may also be used to authenticate user accounts.

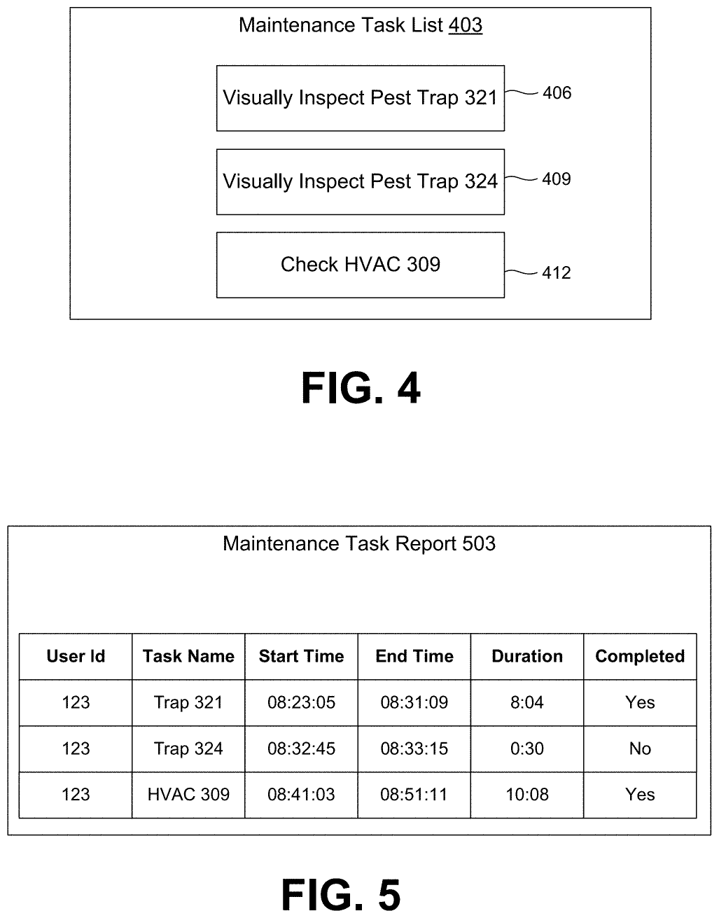

The task data 233 can include data about various tasks that need to be performed and tracked in the manufacturing facility 100 using various embodiments of the present disclosure. An example of a task list is shown in FIG. 4. Other variations of task lists can also be stored as task data, as can be appreciated by one skilled in the art. The task data 233 can also store event data received from beacons devices 206 and other devices. The task data 233 can also store historic data about tasks, such as completed tasks, duration to complete the tasks, as well as user devices that completed the tasks. The task data 233 can be used by a machine learning application executed in the computing environment 203 to determine efficiencies, trends, and other metrics. For example, the metrics can include a comparison of efficiencies of various users, a comparison of effectiveness of various users, or other metrics.

The beacon device data 236 can include data about beacon devices 206a, 206b, 206c, and other devices. The beacon device data 236 may include information about a location of the beacon, such as equipment, task areas, and other locations. In some embodiments, a location of the beacon device 206 can be determined using one or more sensors 262, such as real-time location system (RTLS) sensors. The beacon device 206 can determine a location by communicating with the sensors 262.

The sensors 262 can be placed in the facility to form a mesh network to cover the area that needs to be tracked. The sensors 262 can communicate with gateway 215. The sensors 262 can also communicate with beacon devices 206. The sensors 262 can detect beacon devices 206 within range and can pair to new beacon devices 206.

One or more beacon devices 206 can communicate through one or more sensors 262. In various embodiments, a beacon device 206 can communicate via the closest sensor, or the sensor that has the highest signal strength. In various embodiments, a beacon device 206 may communicate via two or more sensors for redundancy purposes. The sensors 262 may use techniques such as geolocation, signal triangulation, etc., to determine a location of one or more beacon devices 206.

The beacon device data 236 may include data to control the geofence of the beacon device, such as a power transmit level to control the geofence size, firmware information, associated zones and/or equipment within the facility, and other information. The beacon device data 236 can also store activity of client devices within the geofences of each beacon. For example, the beacon device data 236 may include a log of all activity, such as entry events, exit events, present events, pairing events, and others that correspond to the activity of a client device, for each of beacon devices. Further, the beacon device data 236 can also store polling data for each of the beacon devices. For example, sensors 262 may poll each of the beacon devices 206a, 206b, and 206c at predetermined or random intervals. The results of this polling activity can be sent by the sensors 262 to the computing environment 203 to store in the beacon device data 236. The polling data can include a timestamp, a battery level of the beacon device 206, a signal strength of the beacon device 206, a firmware version, identifiers of client devices present within a geofence of the beacon device 206, and other operational data that is reportable by the beacon devices 206.

The beacon manager 224 can push new firmware or software to the beacon devices 206, sensors 262, the gateway 215, and the client devices 209. The beacon manager 224 can monitor a battery life of the beacon devices 206, the gateway 215, and the client devices 209. The beacon manager 224 can manage configuration, deployment, and monitoring of beacon devices 206 and gateway 215.

The client 250 is representative of one of a plurality of computing devices that may be coupled to the network 218. The client 250 may include, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client 250 may include a display 256. The display 256 may include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 250 may be configured to execute various applications such as a client application 253 and/or other applications. The client application 253 can access network content served up by the computing environment 203 and/or other servers, thereby rendering a user interface 259 on the display 256. To this end, the client application 253 can include a browser, a dedicated application, and other applications. The user interface 259 can include a network page, an application screen, etc. The client 250 may be configured to execute applications beyond the client application 253 such as, for example, email applications, social networking applications, word processors, spreadsheets, and/or other applications. The client 250 can communicate with computing environment 203 to invoke task application 226 and/or the reporting application 228. When the client 250 invokes the task application 226 and/or the reporting application 228, the task application 226 and/or the reporting application 228 cause the client 250 to generate the user interface 259.

The user interface 259 can display a list of tasks associated with a user account. The user interface 259 can indicate a progress of completion of the task. As an example, the user interface 259 can show that a five of the twelve items on a task list are complete. The user interface 259 can also show details on how to complete the remaining seven items. The user interface 259 can show information about invoices associated with the task including amount owed from completed tasks, an amount associated with tasks partially compete, and an amount associated with tasks to be completed. The reporting application 228 can generate various reports and/or information screens to be presented via the user interface 259. For example, the reporting application 228 can generate an interface to display the details of beacon devices 206, sensors 262, gateway 215. The details can include status information, firmware version, time since reboot, health information, battery level, signal strength, client devices, if any, within range of the beacon devices 206, and other information.

The reporting application 228 can generate an activity log for a particular client device 209 or one or more of the beacon devices 206. The activity report may show the activity corresponding to the selected client device 209 or beacon device 206. For example, for a selected client device 209, the activity report may show, for a selected time frame, various geofences entered by the client device 209, the time corresponding to the entry and exit for each of the geofences and duration spent in each of the geofences. The activity report may also show corresponding tasks that were determined to be performed on the basis of the user account corresponding to the selected client device 209. The activity report can also indicate whether the tasks were completed and the payment amount for each of the tasks.

According to various embodiments, the beacon devices 206, the sensors 262, and others communicate with gateway 215 using wireless communication, such as for example, Wi-Fi (802.11) or mobile data communication module (3G/ LTE, GSM, etc.), Bluetooth, Bluetooth Low Energy (BLE 5.0), NFC, Zigbee, Z-wave, IR, etc. The beacons 206a, 206b, and 206c can communicate with the gateway 215 via sensors 262. The sensors 262 can form a mesh network across the facility. In some embodiments, sensors 262 can communicate with each other using a first wireless communication network and communicate with gateway 215 using a second different wireless communication network or a wired communication network. As an example, a first frequency band can be used for the first wireless network and a second frequency band can be used for the second wireless network. In various embodiments, beacon devices 206 communicate with sensors 262 using a different wireless communication networks than that used by sensors 262 to communicate with each other. In various embodiments, the beacon devices 206, the sensors 262, and others communicate with gateway 215 using wired communication such as Ethernet or another wired connection.

In various embodiments, the beacon devices 206 and the sensors 262 use Bluetooth 5.0 LE (Low Energy) technology. Bluetooth 5.0 provides the ability for the BLE devices to communicate via a mesh, thus eliminating the need for a secondary network to provide communication. The sensors 262 can form the mesh network. The meshing capability allows the BLE devices to communicate with each other to transmit and process data hopping off each device. The data can intelligently route back to a single point of egress, such as the gateway 215, allowing for communication to the computing environment 203. In various embodiments, the sensors 262 use Bluetooth 5.0 spread spectrum technology to voice co-channel interference. The meshing capability can facilitate an endless number of devices, such as sensors 262, to communicate with each other without the requirement of a secondary network. Additional beacon devices can be added as long as the additional beacons are in proximity to sensors 262. In some embodiments, the beacon devices can include the mesh network capability directly. In these embodiments, as long as the furthest beacon device is within range of another beacon device 206 or sensor 262 closer to the gateway 215, additional beacon devices can be added.

Various network security techniques can be utilized to ensure that data communication between beacon devices 206, sensors 262, and gateway 215 is secure. For example, communication between the various devices can be encrypted using 128-bit AES encryption. Additionally, the beacon devices 206 and sensors 262 can utilize frequency hopping techniques to avoid the capture of wireless data. The beacon manager 224 can maintain a list of authorized devices such as beacon devices 206 and sensors 262. If a device that is not authorized attempts to communicate with the computer environment 203, the beacon manager 224 can generate an alarm or alert.

In various embodiments, beacon devices 206, sensors 262, and gateway 215 have authentication capabilities to ensure only authorized devices are added to the network. On chip encryption can be utilized to encrypt all network traffic to avoid data being compromised if hardware is stolen. Fast roaming/pairing capability between beacon devices 206, sensors 262, and gateway devices 215 that utilize Bluetooth further adds to security.

In some embodiments, various other devices apart from the client device can utilize the mesh network created by the beacon devices 206 and sensors 262 to communicate with computing environment 203. Other Internet of Things (IoT) devices may communicate with computing environment 203. For example, there may be machinery being used in the facility that may include one or more IoT device. The IoT devices may use the mesh network to communicate with the computing environment 203.

In one embodiment, the computing environment 203 can be coupled to a surveillance system that includes one or more cameras. The task application 226 can determine that a client device 209 enters into a geofence by analyzing a video feed. Entry and exit events can be generated based on analyzing the video feed. In some embodiments, when an entry or exit event is received from a beacon device 206, the task application 226 can verify the event by analyzing a video feed. When a discrepancy exists, the task application 226 can initiate an action. As an example, the task application 226 can send a video recording for manual review. An administrator can review the video recording to determine whether the event was valid. If the administrator indicates the event is not valid, the task application 226 can prevent a user account associated with the client device 209 from completing further tasks until a diagnosis of the problem is identified.

The disclosed systems and methods provide the ability to create geofences and monitor when client devices 209 enter the geofence. A history of movement can be captured as well as a time that each client device 209 spends within the geofence. The computing environment can perform predictive analysis on the captured data to optimize work schedules and processes. The predictive analysis may include determining an optimal duration before a next scheduled maintenance event, which can be based on a duration between previous maintenance events on that same equipment and other similar equipment within the facility. The work schedules may also be optimized on the basis of time being spent on various locations within the facility of various different user accounts and/or user role types.

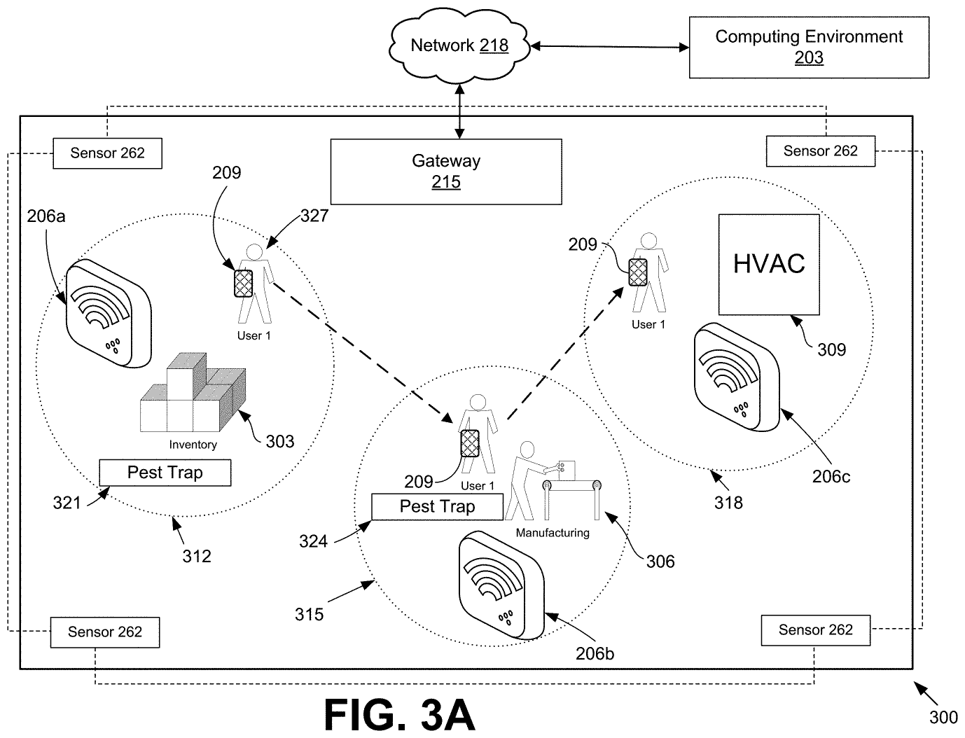

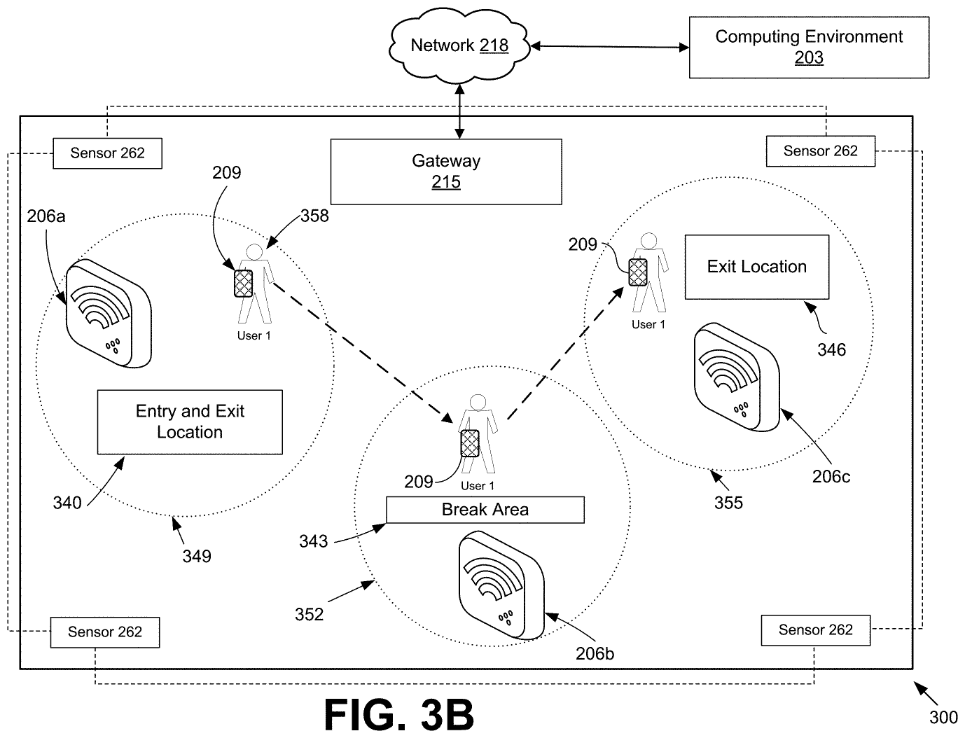

Turning now to FIG. 3A, shown is a drawing of a networked environment 300a in which tasks are tracked using geofences according to various example embodiments of the present disclosure. The networked environment 300a depicts a facility that includes an inventory location 303, a manufacturing location 306, and an HVAC 309. The beacon device 206a is located in the vicinity of inventory location 303, the beacon device 206b is located in the vicinity of manufacturing location 306, and the beacon device 206c is located in the vicinity of HVAC 309.

In the illustrated embodiment, the beacon device 206a creates a geofence 312 which surrounds inventory location 303. The beacon device 206b creates a geofence 315 which surrounds manufacturing location 306. The beacon device 206c creates geofence 318 which surrounds HVAC 309. A pest trap 321 is located within geofence 312 and a pest trap 324 is located within geofence 315. In some embodiments, a task list may need to be completed on a frequent basis by a maintenance technician. The maintenance technician or user 327 can carry a client device 209 on their person.

In some embodiments, the client device 209 is a passive device, such as a radio frequency identification device (RFID). In other embodiments, the client device 209 is a device that can communicate with beacon devices 206a, 206b, 206c, and others over BLE. In yet other embodiments, the client device 209 is a smartphone or a mobile phone with Bluetooth or BLE capabilities. The beacon device 206a can detect when the client device 209 enters geofence 312. The beacon device 206a can measure the signal strength of the client device 209 and determines that the client device 209 is within the geofence 312 when the signal strength is above a predefined/predetermined threshold. The signal strength may be measured on the basis of a constant or periodic signal being emitted by the client device 209. The beacon device 206a can identify an identifier, such as a MAC id, associated with the client device 209. The client device 209 can emit a periodic signal, such as, e.g. every 5 seconds. When the client device is within a geofence, such as geofence 312, the beacon device 206a can receive the emitted signal. The emitted signal can include an identifier associated with client device 209.

When the beacon device 206 identifies that a client device 209 has entered the geofence 312 of the beacon device 206, the beacon device 206 can transmit the identifier associated with client device 209 to the computing environment 203. The beacon device 206 can also transmit an identifier associated with the beacon device 206 to computing environment 203.

In various embodiments, the identifier of the client device 209 and the identifier of the beacon device 206a are transmitted as one or more data packets, for example, on the occurrence of one or more events. The data packets can include a timestamp and an event identifier. The event identifier can include an entry event, an exit event, a presence event, etc. The beacon manager 224 can receive the data from beacon device 206a. In response to receiving the data, the beacon manager 224 may determine that the data received corresponds to a task event and invoke task application 226. The task application 226 can determine the type of event. In the content of the present example, the task applicant 226 can determine that the event is an entry event that corresponds to the beacon device 206a and client device 209. The task application 226 can query user account data 230 to determine a user account associated with client device 209. In various embodiments, the user account can have a corresponding user ID and a role. The role may correspond to one or more task lists stored in task data 233. In various embodiments, the user account may correspond to one or more task lists stored in task data 233. The task application 226 can determine that the client device 209 corresponds to a user account with user ID 123. The task application 226 can further determine that the user ID 123 corresponds to a specific task list. The task list can include one or more tasks that each correspond to one or more locations of beacon devices 206.

The task application 226 can also determine that the data received corresponds to an entry event of the beacon device 206a entering the geofence 312. The task application 226 can query the beacon device data 236 and/or the task data 233 to determine a task that corresponds to beacon device 206a. In this example, the task application 226 determines that the beacon device 206a corresponds to a first task corresponding to inspecting the pest trap 321 that is located within the geofence 312. The task application 226 may record the start of task in data store 221 with a date/time stamp by creating a record, a log entry, etc.

In various embodiments, while the client device 209 remains in the geofence 312, the beacon device 206a transmits one or more events indicating the presence of the client device 209 in the geofence 312. The one or more events may be transmitted by the beacon device 206a to computing environment 203 including the identifier associated with the beacon device 206a and the event type.

When the user 327 completes the first task, i.e., visually inspecting the pest trap 321 the user 327 can leave the area surrounding the pest trap 321. As a result, the client device 209 can leave geofence 312. The beacon device 206a can detect that the client device 209 is no longer within the geofence 312. In various embodiments, the beacon device 206a can periodically send a message to determine if the client device 209 is within range. The client device 209 can receive the message and sends back a confirmation indicating that the client device 209 is within range. Such messages can be sent at a configurable frequency. Examples of the frequency of these messages may be a fraction of seconds, seconds, minutes, etc., as will be appreciated by those skilled in the art. In various other embodiments, the client device 209 can send messages at predetermined intervals. As long as the client device 209 is within the geofence 312, the beacon device 206a can receive these messages. When the client device 209 leaves the geofence 312, these messages may not be received by the beacon device 206a. Therefore, the beacon device 206a may determine that the client device 209 has left the geofence 312.

When the client device 209 leaves the geofence 312, the beacon device 206a sends an event to the computing environment 203. The beacon manager 224 can receive the event from the beacon device 206a. In various embodiments, the event can also contain the identifier associated with the beacon device 206a, the identifier associated with the client device 209, an event type, and a time stamp.

The beacon manager 224 can determine that the data received from the beacon device 206a is an exit event and pass the event type along to the task application 226. The task application 226 can then parse the data and store it in the task data 233. The task application 226 can also determine that the event is an exit event and cause the reporting application 228 to execute an action. The reporting application 228 can compute the total time spent working on the first task by the user account by retrieving or accessing the data stored corresponding to the first task in the task data 233. In various embodiments, the reporting application 228 can determine the start time and end time of the first task. The total time spent by a user account can be the difference between the end time and the start time for that user account for that task. The total time spent can also be the sum of differences between multiple end times and start times. The reporting application 228 can also compare the total time spent to a minimum time required, which can be stored in the task data 233, for example, along with the task list.

The reporting application 228 can execute an action if the total time spent meets or does not meet the minimum time required for that task. Examples of actions can include sending an alert notification to one or more designated users along with information about the task and other actions. The information about the task can include start time, end time, total time, task description, user performing the task, past history of that user's performance on that and/or other tasks, or other information. Alert notifications can be sent via email, short message service (SMS), an in-app notification delivered to a mobile application residing on the designated users' smartphone and/or computing devices, etc. Another example of the action can be recording information in the data store 221. The information recorded can include the task information, start time, end time, total time, task description, user assigned to task, past history of the user's performance on that task, and/or other information.

The user 327 may move from the inventory location 303 to a different location, such as the manufacturing location 306, to complete a different task. The task application 226 can determine that the task to be completed is a second task on the basis of the client device entering geofence 315 corresponding to beacon device 206b. The second task involves inspecting pest trap 324. The beacon device 206b can create a geofence 315 that surrounds the manufacturing location 306. The pest trap 324 is located within the geofence 315. When the client device 209 enters geofence 315, the beacon device 206b can detect that the client device 209 is within the geofence 315 and send data to the computing environment 203 indicating an entry event. The beacon manager 224 can receive the entry event and send the information to the task application 226 that can record the entry event in the task data 233, in accordance with various embodiments described herein.

When the user 327 completes visually inspecting the pest trap 324, or the second task, the user 327 leaves the area surrounding the pest trap 324. As a result, the client device 209 leaves the geofence 315. The beacon device 206b can detect the client device 209 is no longer within the geofence 315. When the client device 209 leaves the geofence 315, the beacon device 206b sends an exit event to the computing environment 203. The beacon manager 224 can receive the exit event from the beacon device 206a and send the information to the task application 226 that can record the exit event in task data 233, in accordance with various embodiments described herein.

The user 327 may move from the manufacturing location 306 to a different location, such as HVAC 309. The beacon device 206c creates a geofence 318 which surrounds the HVAC 309. The HVAC 309 is located within the geofence 318. When the client device 209 enters the geofence 318, the beacon device 206c can detect that the entry event and send data to computing environment 203 indicating the client device 209 entered the geofence 318. The beacon manager 224 can receive the entry event and send the information to the task application 226. The task application 226 can record the entry event in the task data 233. The task application 226 can determine that the task to be completed is a third task on the basis of the client device 209 entering geofence 318 corresponding to beacon device 206c. The third task may include visually inspecting the HVAC 309.

When the user 327 completes visually inspecting the HVAC 309 the user 327 can leave the area surrounding the HVAC 309. As a result, the client device 209 leaves the geofence 318. The beacon device 206c can detect the client device 209 is no longer within the geofence 318. When the client device 209 leaves the geofence 318, the beacon device 206c can send an exit event to the computing environment 203. The beacon manager 224 can receive the exit event from the beacon device 206b and send the exit event to the task application 226 that can record the exit event in the task data 233. Hence, according to the example described herein, the user 327 may complete the task list.

Turning now to FIG. 3B, shown is a drawing of a networked environment 300b in which tasks are tracked using geofences according to various example embodiments of the present disclosure. The networked environment 300b depicts a facility that includes an entry and exit location 340, a break area 343, and an exit location 346. The beacon device 206a is located in the vicinity of entry and exit location 340, the beacon device 206b is located in the vicinity of the break area 343, and the beacon device 206c is located in the vicinity of the exit location 346.

In the illustrated embodiment, the beacon device 206a creates a geofence 349 which surrounds the entry and exit location 340. The beacon device 206b creates a geofence 352 which surrounds the break area 343. The beacon device 206c creates geofence 355 which surrounds the exit location 346. In some embodiments, an entry time and an exit time may be recorded for one or more employees, contractors, etc., entering and leaving the facility 100. A task list may be tracked in accordance with the networked environment 300 to record an employee or contractor's clock in and clock out activity. The task list can be a time card. For example, a contractor 358 may carry a client device 209 when at the facility 100. When the contractor 358 enters at the entry and exit location 340, the client device 209 enters the geofence 349. The beacon device 206a can detect the entry of client device 209 and send a corresponding event to the task application 226. The task application 226 can store the event in the task data 233.

The contractor 358 may take a break by entering a break area, such as a cafeteria, gymnasium, employee lounge, etc. For example, when contractor 358 enters break area 343, the beacon device 206b can detect the client device 209 entering in to the corresponding geofence 352. The beacon device 206b can send the break area entry event to task application 226, in accordance with various embodiments described herein. When the contractor 358 leaves the break area 343, the beacon device 206b can detect that the client device 209 is no longer in the geofence 352. The beacon device 206b can send the break area exit event to the task application 226.

The task application 226 can store this in the task data 233. Further, the task application 226 can also determine the amount of time spent in break area 343, and store the amount of time in the task data 233. Also, the task application 233 may determine the sum of all the time spent in break areas, in any given time range, such as one working shift, day, week, pay-period, etc.

The contractor 358 can leave the facility 100 at one or many exit locations. One of the exit locations may correspond to the entry and exit location 340. There may be other exit only locations at the facility 100, such as exit location 346. When the contractor 358 leaves the facility 100 via the exit location 346, the client device 209 may enter the geofence 355 and then exit the geofence 355. The beacon device 206c can detect this event and send the event data to the task application 226. The task application 226 can store the clock out event in the task data 233. In certain embodiments, where the entry location and the exit location is the same, such as entry and exit location 340, the task application 226 may use some rules, heuristics, machine learning, etc. to determine whether the client device is entering the facility 100 (clocking in) or leaving the facility 100 (clocking out).

In some embodiments, two or more beacon devices may be used near the entry and exit location 340 and the order in which the client device enters each corresponding geofence may be used by the task application 226 to determine whether it is a clock in event or a clock out event. In other embodiments, task application 226 can interface with third-party systems to determine whether certain events are clock-in events or clock-out events. The task application 226 may determine the start of a shift of a particular employee or contractor corresponding the client device 209 entering geofence 340 corresponding to the entry and exit location 340. The task application 226 may then determine whether the client device 209 had a clock in event associated with the client device 209 subsequent to a shift starting. If not, then this would be the clock in event. If a previous clock in event is recorded in task data 233, then this next event will be a clock out event. Even further, the task application 226 may also determine if there is a previous clock out event recorded for the client device 209 in the present shift or the previous day/shift to make a determination of whether this is a clock in event or a clock out event.

In various embodiments, one or more clients 250 may be located at the entry and exit locations, such as at the entry and exit location 340 and the exit location 346. The client application 253 can display a user interface 259 that allows an employee or contractor to manually record clock in and clock out events. The client 250 may require the employee or contractor to authenticate using one or more authentication methods, prior to recording the clock in and clock out events. For example, the employee may enter a unique identifier such as a pin code prior to recording the event. The employee may use a biometric identifier, such as a fingerprint to record an event. Further, the client 250 may include a beacon device 206 with a geofence that may detect the client device 209 in proximity to the client 250. Additionally, the client application 253 may allow the employee or contractor to query the data store 221 for the task data 233, such as the task data 233 relating to that particular employee or contractor's previous clock in and clock out activity. In certain embodiments, the reporting application 228 can provide such a report by querying the task data 233 and retrieving the data and sending it to client 250.

In various embodiments, a third-party system, such as a payroll management, access management, video surveillance, or similar system can be used in conjunction with the systems and methods described in the present disclosure as a primary method or to augment tracking of entry and exit times of various employees and contractors. The computing environment 203 can query the third-party system to retrieve specific data. The computing environment 203 may store certain data useful in querying the third-party system, for example, API calls, SQL queries, etc. In various embodiments, task data 233 can store the minimum number of hours for certain employees and contractors.

At the end of a time period, such as a single shift, a day, a week, a pay-period, etc., or when an employee or contractor clocks out for the day/shift, the task application 226 or the reporting application 228 can run queries on the task data 233 to determine if there are certain employees and contractors that have not met the minimum number of hours. The computing environment 203 can query the third-party system to retrieve the clock in and clock out times for those employees and contractors. The computing environment 203 can then compare the clock in and clock out times stored in task data 233 with those retrieved to determine discrepancies. In various embodiments, the reporting application 228 can generate a report that shows the time entries for the employees and contractors that do not meet the minimums set for those employees and contractors. Further, the reporting application 228 can also display where there is a discrepancy between the data stored in the task data 233 and in the third-party system. In certain embodiments, the reporting application 228 may display the discrepancies regardless of whether the time entries meet the minimum time. The certain embodiments, the reporting application 228 may generate an event, such as an alert when it determines a discrepancy exists.

FIG. 4 illustrates an example task list according to various example embodiments of the present disclosure. The task list 403 includes tasks 406, 409, and 412. In various embodiments, the task list 403 can be the task list to be assigned to a user account associated with the client device 209. The task application 226 can record the completion of the task list 403 in the task data 233 in addition to recording the completion of the individual tasks 406, 409, and 412, as described herein. The task list 403 may need to be completed by more than one technician. Each completion of the task list 403 and tasks within the task list 403 can be recorded by the task application 226 in the task data 233. In various embodiments, the tasks 406 and 409 can be a single task and correspond to a single duration. For example, the tasks 406 and 409 may have a corresponding minimum duration of 3 minutes. If a client device 209 spends one minute in a geofence corresponding to the pest trap 321 and 2 minutes in a geofence corresponding to the pest trap 324, the total duration of 3 minutes meets the minimum required for the combined task 406 and 409 and the task may be considered completed.

The computing environment 203 can execute various actions based on the task data 233. For example, the reporting application 228 can execute an action if the total time spent on a task meets or does not meet the minimum time required for that task. The computing environment 203 can generate a maintenance task report after the completion of all or some of the tasks in a task list. In various embodiments, the task list can only require storing an entry time or an exit time, and not the duration the client device was within a geofence.

In one embodiment, the computing environment 203 can verify manually entered records from the third-party system. As an example, the computing environment 203 can determine an employee that entered the building at 9:42 AM and forgot to punch in, manually entered that the employee arrived at 9:30 AM. The computing environment 203 can take a remedial action in response to determining a discrepancy exists. The remedial action can include sending a notification to a supervisor for the employee or contractor, adjusting the time entry, imposing a fine on the employee or contractor, increasing or decreasing a compensation for the employee or contractor, sending a warning to the employee or contractor, or some other remedial action. The computing environment 203 can track a number of occurrences of discrepancy. In some embodiments, the remedial action can be taken after a threshold number of discrepancies are identified.

Turning now to FIG. 5, depicted is an example maintenance task report in accordance with various embodiments of the present disclosure. The reporting application 228 can generate various reports, such as a maintenance task report 503. In various embodiments, the maintenance task report 503 can be generated in response to certain predetermined events. For example, the maintenance task report 503 can be generated after each completion of the task list 403 by a user. In various embodiments, the maintenance task report 503 can be generated on request the client 250 via a client application 253 to access the computing environment 203. The maintenance task report 503 can include a user ID, a task name, a start time, an end time, duration, whether the task was completed, and potentially other fields. Whether the task was completed can be determined by comparing the task duration to a minimum duration specified for that task.

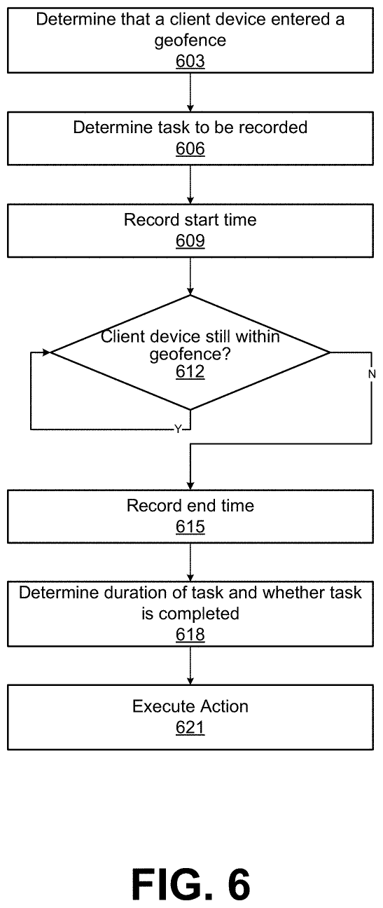

Before turning to the process flow diagram of FIG. 6, it is noted that embodiments described herein may be practiced using an alternative order of the steps illustrated in FIG. 6. That is, the process flow illustrated in FIG. 6 is provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope and spirit of the embodiments.

FIG. 6 is a flowchart illustrating one example of functionality implemented as portions of a task application 226 (FIG. 2) executed in a computing environment 203 (FIG. 2) in the networked environment 200 (FIG. 2) according to various embodiments of the present disclosure.

Beginning with box 603, the task application 226 determines that a client device 209 entered a geofence. In various embodiments, the beacon manager 224 can invoke the task application 226 when the beacon manager 224 determines that a client device 209 has entered a geofence.

At box 606, the task application 226 can determine a task that is to be assigned, completed, or recorded. In various embodiments, the task application 226 can receive information identifying the geofence, the beacon device, and/or the client device. The task application 226 can query various data stored in data store 221, such as the user account data 230, the task data 233, and the beacon device data 236. The task application 226 can determine a user account assigned to the client device, one or more tasks that may be performed by the user account. The determination can be based on a user identifier, a user role, a date, a day or time when the task is being performed or is to be performed, one or more tasks that can be performed in the geofence, or other factors.

In various embodiments, task application 226 can use various rules to determine the task that is to be recorded in case there is more than one task that matches data corresponding to the event. In various embodiments, task application 226 can utilize machine learning to analyze patterns to predict which task is being worked on. For example, the task application 226 may determine that during a certain time, for example, between 8 am and 12 pm, a maintenance technician performs a visual inspection of a pest trap location within a particular geofence. Further, the same maintenance technician performs a visual inspection of machinery located within the same geofence between 12 pm and 1 pm and again between 6 pm and 7 pm.

At box 609, the task application 226 may record a start time associated with the task in data store 221, such as in the task data 233. In various embodiments, the task application 226 can also record additional information or data along with the start time, such as a user ID associated with the client device, an identifier for the client device, an identifier for the beacon device, etc. In various embodiments, the start time associated with the task may be the time the client device enters the geofence. In various embodiments, the start time may be offset by a predetermined amount. In various embodiments, the start time may be calculated based on the time the client device enters the geofence, a predetermined formula, manual input by a user, machine learning algorithms, or other methods.

At box 612, the task application 226 can determine if the client device is within the geofence. Once a client device is within a geofence, task application 226 may periodically, or after a predetermined time period has elapsed, determine whether the client device is still within the geofence. The beacon device can send messages to a client device at predetermined intervals. The client device can also send or transmit one or more messages at predetermined intervals. The messages can be received by a beacon device when the client device is within the geofence associated with the beacon device. The messages can be transmitted to the beacon manager 224 by the beacon devices. The beacon manager 224 can maintain and update a list of various beacon devices and client devices that are within the geofence of each of those beacon devices. In various embodiments, the task application 226 may query the beacon manager 224 to determine if a particular client device is within the geofence of a particular beacon device.

If the client device is determined to be within the geofence of the beacon device where the task is being performed, the task application 226 can wait a predetermined period of time and repeat the query again. The loop can continue until the task application 226 determines that the client device is no longer within the geofence of the beacon device.

At box 615, the task application 226 can record an end time associated with the task that is being performed. In various embodiments, the task application 226 can also record additional information or data along with the end time, such as a user id associated with the client device, an identifier for the client device, an identifier for the beacon device, etc. The end time associated with the task can be the time the client device leaves the geofence. The end time can be offset by a predetermined amount. The end time can be calculated based on the time the client device enters the geofence, the time the client device leaves the geofence, a predetermined formula, manual input by a user, machine learning algorithms, or other factors. The end time may be the time the client device enters a different geofence, such as a geofence associated with a difference beacon device.

At box 618, the duration of time spent on a task is determined. This task can correspond to a recently completed task or another task that has been previously completed. The duration can be determined by determining the total time a client device was within the geofence corresponding to the task. In various embodiments, the total time may be determined by the difference between the end time of a task and a start time of a task. The duration can be determined based on multiple start and end times of a task. For example, a client device may enter a geofence, leave the geofence, and enter the geofence again after a short period of time. When the client device leaves the geofence the second time, the duration for the task can be determined to include the duration of the first presence and the duration of the second presence. The duration spent on a task can be compared to a required duration associated with the task, which can be stored in data store 221, to determine whether the task is completed.

At box 621, an action may be executed by task application 226. The action can include providing an alert, sending a notification, authorizing a payment for completion of the task, sending task list to a client 250, or some other action. The action can be based on the determination on whether the task was completed or not. In various embodiments, if a task is incomplete, then an action can be taken. The action can be to send an alert or notification to one or more clients 250 identifying the task and the user account associated with the task. If a task is completed, another action can be taken. As an example, the action can be to send an alert or notification to one or more clients 250 identifying the task and the user account associated with the task.

In some embodiments, a task may be considered incomplete if a client device 209 leaves a geofence corresponding to the task location. The task application 226 can determine that the client device 209 did not spend a minimum time associated with that particular task/geofence. The task application 226 may combine the duration of two of more entry-exit sequences as a single duration to determine whether the task is complete or incomplete.

In some embodiments, the task application 226 can authorize a payment for completion of the task. For example, data store 221 can store a bank account or another indication of a payment processor associated with a user account. Once a task or a task list is completed by the client device 209, the computing environment 203 (FIG. 2) may initiate a payment based on the bank account information or payment processor information corresponding to the user account. In some embodiments, an alert may be sent to an account to authorize release of payment to the user.

In some embodiments, the task application 226 can send a task list to the client 250. For example, a user account assigned to a maintenance role may be sent the task list 403. After the task 406 is completed, an alert or notification can be sent to the client 250 to complete task 409. After the task 409 is complete, an alert or notification can be sent to the client 250 to complete the task 412. After the completion of a task, an alert may be sent to the client 250 associated with the user account to notify them to proceed to the next task. The alert can identify the location of the task, task description, duration required to complete the task, etc. In certain embodiments, the client 250 may also display a notification indicating that the client device 209 is within the correct geofence. Additionally, the computing environment 203 may send client 250 instructions that cause the display 256 to show a countdown indicating the time remaining for the completion of the current task. The alerts or notifications may be sent by the reporting application 228 via the network 218.

The user account data 230 can store user based policies that determine when alerts are to be generated and/or sent to specific user accounts. The computing environment 203 can store the user based policies in the user account data 230. For example, the user interface 259 may include various interfaces to configure the user based policies. The reporting application 228 can query the user account data 230 for the user based policies on the occurrence of an event to determine the list of user accounts to receive alerts. Further, the user based policies may also specify when the policies are breached or reached. This enables the ability to streamline workflows and prioritize events that may require immediate attention. For example, certain actions on certain tasks may cause immediate notifications, whereas other actions on the same and/or different tasks may only cause a report to be generated at a later time.

In some embodiments, a performance rating is stored in the data store 221 that corresponds to each user account that performs tasks. The performance rating can indicate an efficiency for performance of one or more tasks or a measure of an ability of the user to complete tasks. For example, a percentage of successfully completed tasks to total number of tasks completed can be used as a measure of the performance rating. After each task is complete, an action can be taken to update the performance rating of the user account in data store 221.

The task application 226 can determine whether a task is completed based on a minimum duration to be spent and a maximum duration to be spent for the task. For example, if a client device 209 spends more than the maximum duration within a geofence or if the client device 209 spends less than the minimum duration within the geofence, then the task may be determined to be incomplete. The maximum duration and/or the minimum duration may be stored individually for each task, e.g., in task data 233 or in task list 403. In various embodiments, the maximum duration and/or the minimum duration are the same for all tasks that correspond to a single type of task. The performance rating can also provide a measurement or rating of the efficiency of a user. For example, one user who completes tasks in a duration that meets the minimum may be more efficient than a user who completes tasks in a duration that is closer to the maximum duration. In various other embodiments, the computing environment 203 may determine that a user is not properly completing tasks, even though the duration of the client device 209 within the geofence is within the predefined range based on a feedback from a supervisor. For example, the task application can send a request for feedback in order to rate whether the task was completed by the user. If the rating received indicates that the task was not completed, even though the minimum threshold for the task was met, the task application 226 can mark the task as incomplete.

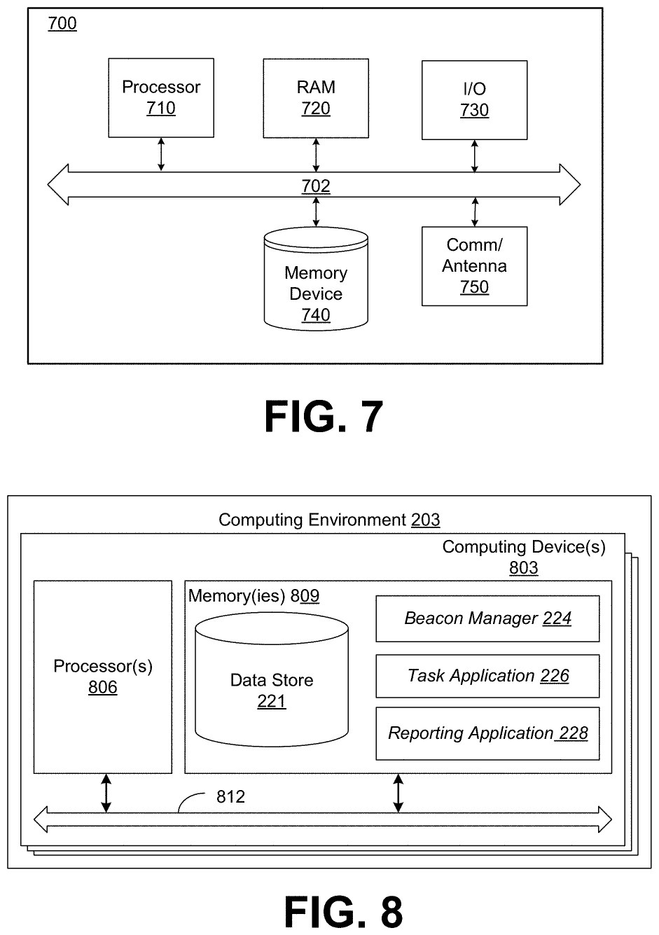

Turning to FIG. 7, an example hardware diagram of a beacon device, such as beacon device 206a or a client device 209 is illustrated. The device 700 includes a processor 710, a Random Access Memory (“RAM”) 720, an Input Output (“I/O”) interface 730, a memory device 740, and a communication interface/ antenna 750. The elements of the device 700 are communicatively coupled via a bus 702.

The processor 710 comprises any well-known general purpose arithmetic processor or Application Specific Integrated Circuit (“ASIC”). The processor 710 may include a System on Chip (SOC) processor, for example, an nRF52840 SOC from Nordic Semiconductor. The RAM 720 comprise any well-known random access or read only memory device that stores computer-readable instructions to be executed by the processor 710. The memory device 740 stores computer-readable instructions thereon that, when executed by the processor 710, direct the processor 710 to execute various aspects of the present disclosure described herein. When the processor 710 comprises an ASIC, the processes described herein may be executed by the ASIC according to an embedded circuitry design of the ASIC, by firmware of the ASIC, or both an embedded circuitry design and firmware of the ASIC. As a non-limiting example group, the memory device 740 comprises one or more of an optical disc, a magnetic disc, a semiconductor memory (i.e., a semiconductor, floating gate, or similar flash based memory), a magnetic tape memory, a removable memory, combinations thereof, or any other known memory means for storing computer-readable instructions. The communication interface/antenna 750 comprises hardware interfaces to communicate over data networks. The I/O interface 730 comprises device input and output interfaces such as keyboard, pointing device, display, communication, and other interfaces. The bus 702 electrically and communicatively couples the processor 710, the RAM 720, the I/O interface 730, the memory device 740, and the communication interface/antenna 750, so that data and instructions may be communicated among them.

In operation, the processor 710 is configured to retrieve computer-readable instructions stored on the memory device 740, the RAM 720, the ROM, or another storage means, and copy the computer-readable instructions to the RAM 720 or the ROM for execution, for example. The processor 710 is further configured to execute the computer-readable instructions to implement various aspects and features of the present disclosure. For example, the processor 710 may be adapted and configured to execute the processes described above with reference beacon devices 206a, 206b, and 206c and/or client device 209.

With reference to FIG. 8, shown is a schematic block diagram of the computing environment 203 according to an embodiment of the present disclosure. The computing environment 203 includes one or more computing devices 803. Each computing device 803 includes at least one processor circuit, for example, having a processor 806 and a memory 809, both of which are coupled to a local interface 812. To this end, each computing device 803 may comprise, for example, at least one server computer or like device. The local interface 812 may comprise, for example, a data bus with an accompanying address/control bus or other bus structure as can be appreciated.

Stored in the memory 809 are both data and several components that are executable by the processor 806. In particular, stored in the memory 809 and executable by the processor 806 are the beacon manager 224, the task application 226, and the reporting application 228, and potentially other applications. Also stored in the memory 809 may be a data store 221 and other data. In addition, an operating system may be stored in the memory 809 and executable by the processor 806.

It is understood that there may be other applications that are stored in the memory 809 and are executable by the processor 806 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 809 and are executable by the processor 806. In this respect, the term “executable” means a program file that is in a form that can ultimately be run by the processor 806. Examples of executable programs may be, for example, a compiled program that can be translated into machine code in a format that can be loaded into a random access portion of the memory 809 and run by the processor 806, source code that may be expressed in proper format such as object code that is capable of being loaded into a random access portion of the memory 809 and executed by the processor 806, or source code that may be interpreted by another executable program to generate instructions in a random access portion of the memory 809 to be executed by the processor 806, etc. An executable program may be stored in any portion or component of the memory 809 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 809 is defined herein as including both volatile and nonvolatile memory and data storage components. Volatile components are those that do not retain data values upon loss of power. Nonvolatile components are those that retain data upon a loss of power. Thus, the memory 809 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 806 may represent multiple processors 806 and/or multiple processor cores and the memory 809 may represent multiple memories 809 that operate in parallel processing circuits, respectively. In such a case, the local interface 812 may be an appropriate network that facilitates communication between any two of the multiple processors 806, between any processor 806 and any of the memories 809, or between any two of the memories 809, etc. The local interface 812 may comprise additional systems designed to coordinate this communication, including, for example, performing load balancing. The processor 806 may be of electrical or of some other available construction.

Although the beacon manager 224, the task application 226, and the reporting application 228, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 6 shows the functionality and operation of an implementation of portions of the beacon manager 224, the task application 226, and the reporting application 228, and/or the client application 253. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 806 in a computer system or other system. The machine code may be converted from the source code, etc. If embodied in hardware, each block may represent a circuit or a number of interconnected circuits to implement the specified logical function(s).

Although the flowchart of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. Further, in some embodiments, one or more of the blocks shown in FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the beacon manager 224, the task application 226, and the reporting application 228, that comprises software or code can be embodied in any non-transitory computer-readable medium for use by or in connection with an instruction execution system, such as, for example, a processor 806 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the beacon manager 224, the task application 226, and the reporting application 228, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 803, or in multiple computing devices 803 in the same computing environment 203.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phases are not generally intended to, and should not, imply that certain embodiments require at least one of either X, Y, or Z to be present, but not, for example, one X and one Y. Further, such phases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Clause 1. A system, comprising: a plurality of beacons positioned within a facility; a client device; and at least one computing device, the at least one computing device configured to at least: identify a task to be completed within the facility, the task comprising an indication of a first beacon of the plurality of beacons, a second beacon of the plurality of beacons, a first duration corresponding to the first beacon, and a second duration corresponding to the second beacon; detect that the client device entered within a first geofence corresponding to the first beacon; determine a first geofence duration that the client device was within the first geofence; detect that the client device entered within a second geofence corresponding to the second beacon; determine a second geofence duration that the client device was within the second geofence; determine that the task is completed based at least in part on the first geofence duration meeting or exceeding the first duration and the second geofence duration meeting or exceeding the second duration; and in response to the task being completed, execute an action.

Clause 2. The system of clause 1, wherein the at least one computing device is further configured to associate the task to be completed with an account corresponding to the client device.

Clause 3. The system of clause 1 or 2, wherein the at least one computing device is further configured to: identify a different task to be completed within the facility, the different task comprising a third beacon of the plurality of beacons, and a third duration corresponding to the third beacon; detect that a second client device entered within a third geofence corresponding to the third beacon; determine a third geofence duration that the second client device was within the third geofence; determine that the different task is completed based at least in part on the third geofence duration meeting or exceeding the third duration; and in response to the different task being completed, execute a second action.

Clause 4. The system of clause 3, wherein: the task comprises checking a first pest trap located within the first geofence and checking a second pest trap located within the second geofence; and the different task comprises fixing an HVAC system located within the third geofence.

Clause 5. A system, comprising: a plurality of beacons; and at least one computing device, the at least one computing device configured to at least: detect that a client device entered within a first geofence corresponding to at least one of the plurality of beacons; determine a first task to be completed corresponding to the first geofence, wherein the first task is determined based at least in part on the first geofence and an identity of the client device; determine a first duration the client device was within the first geofence; and upon determining that the first duration does not meet a predetermined criteria associated with the first task, execute an action.

Clause 6. The system of clause 5, wherein the action is at least one of: sending an alert to a supervisor, creating a log entry in a data store, sending an email, updating a performance rating associated with the identity of the client device, or including an entry in a report.

Clause 7. The system of clause 5 or 6, further comprising a gateway device in communication with the plurality of beacons over a wireless network, wherein the gateway device is in further communication with the at least one computing device over a second network, the gateway device being configured to facilitate communications between the plurality of beacons and the at least one computing device.

Clause 8. The system of any of clauses 5-7, wherein the first geofence corresponds to a first beacon of the plurality of beacons and a second beacon of the plurality of beacons.

Clause 9. The system of clause 8, wherein the first geofence is a region where a range of the first beacon overlaps with a range of the second beacon.

Clause 10. The system of clause 8 or 9, wherein the first geofence is a region that includes a range of the first beacon and a range of the second beacon.

Clause 11. The system of any of clauses 5-10, wherein the first task corresponds to at least one activity which requires the client device to be present within the first geofence for a required duration.

Clause 12. The system of any of clauses 5-11, wherein the at least one computing device is further configured to determine a second duration the client device was within the first geofence.

Clause 13. The system of clause 12, wherein the at least one computing device is further configured to execute the action upon determining that a sum of the first duration and the second duration does not meet the predetermined criteria associated with the first task.

Clause 14. A method comprising: detecting that a client device entered within a first geofence corresponding to at least one of a plurality of beacons; selecting a first task to be completed at the first geofence by the client device, the first task corresponding to a first duration; detecting that the client device entered within a second geofence corresponding to at least a second one of the plurality of beacons; selecting a second task to be completed at the second geofence by the client device, the second task corresponding to a second duration; and executing an action upon determining that the client device completed at least one of: the first task or the second task.

Clause 15. The method of clause 14, wherein determining that the client device completed the first task further comprises determining that the client device was within the first geofence for a duration greater than the first duration.

Clause 16. The method of clause 15, wherein determining that the client device completed the second task further comprises determining that the client device was within the second geofence for a duration greater than the second duration.

Clause 17. The method of clause 16, wherein the action is executed upon determining that the client device completed the first task and the second task.

Clause 18. The method of any of clauses 14-17, further comprising executing a different action upon determining that the client device did not complete at least one of: the first task or the second task.

Clause 19. The method of any of clauses 14-18, wherein the first geofence surrounds a vicinity of at least one piece of equipment.

Clause 20. The method of clause 19, wherein selecting the first task is based at least in part on the at least one piece of equipment and a role of an account associated with the client device.

Clause 21. A system, comprising: a plurality of beacons; and at least one computing device, the at least one computing device configured to at least: detect that a client device entered within a first geofence corresponding to at least one of the plurality of beacons at a first time; detect that the client device entered within a second geofence corresponding to the at least one of the plurality of beacons at a second time; and upon determining that at least one of the first time, the second time, or a duration does not meet a predetermined criteria associated with the client device, execute an action.

Clause 22. The system of clause 21, wherein the first geofence corresponds to at least one entry location of a facility and the second geofence corresponds to at least one exit location of the facility.

Clause 23. The system of clause 21 or 22, wherein the at least one computing device is further configured to determine the duration based at least in part on the first time and the second time.

Clause 24. The system of clause 23, wherein the at least one computing device is further configured to detect that the client device entered within a third geofence corresponding to the at least one of the plurality of beacons at a third time, and wherein the duration is further based at least on the third time.

Clause 25. The system of any of clauses 21-24, wherein the action comprises receiving data from a data source to determine a discrepancy between the duration and a different duration recorded in the data source.

Clause 26. The system of clause 25, wherein the data source comprises a payroll database.

Clause 27. The system of any of clauses 21-26, further comprising a video surveillance system comprising a first video recording device placed in vicinity of the first geofence and a second video recording device placed in vicinity of the second geofence, wherein the video surveillance system stores.

Clause 28. The system of any of clauses 21-27, wherein the first geofence and the second geofence overlap.

Therefore, at least the following is claimed:

1. A system, comprising:
a plurality of beacons positioned within a facility;
a client device; and
at least one computing device, the at least one computing device configured to at least:
identify a task to be completed within the facility, the task comprising an indication of a first beacon of the plurality of beacons, a second beacon of the plurality of beacons, a first duration corresponding to the first beacon, and a second duration corresponding to the second beacon;
detect that the client device entered within a first geofence corresponding to the first beacon;
determine a first geofence duration that the client device was within the first geofence;
detect that the client device entered within a second geofence corresponding to the second beacon;
determine a second geofence duration that the client device was within the second geofence;
determine that the task is completed based at least in part on the first geofence duration meeting or exceeding the first duration and the second geofence duration meeting or exceeding the second duration; and
in response to the task being completed, execute an action.

2. The system of claim 1, wherein the at least one computing device is further configured to associate the task to be completed with an account corresponding to the client device.

3. The system of claim 1, wherein the at least one computing device is further configured to:
identify a different task to be completed within the facility, the different task comprising a third beacon of the plurality of beacons, and a third duration corresponding to the third beacon;
detect that a second client device entered within a third geofence corresponding to the third beacon;
determine a third geofence duration that the second client device was within the third geofence;
determine that the different task is completed based at least in part on the third geofence duration meeting or exceeding the third duration; and
in response to the different task being completed, execute a second action.

4. The system of claim 3, wherein:
the task comprises checking a first pest trap located within the first geofence and checking a second pest trap located within the second geofence; and
the different task comprises fixing an HVAC system located within the third geofence.

5. A system, comprising:
a plurality of beacons; and
at least one computing device, the at least one computing device configured to at least:
detect that a client device entered within a first geofence corresponding to at least one of the plurality of beacons;
determine a first task to be completed corresponding to the first geofence, wherein the first task is determined based at least in part on the first geofence and an identity of the client device;
determine a first duration the client device was within the first geofence; and
upon determining that the first duration does not meet a predetermined criteria associated with the first task, execute an action.

6. The system of claim 5, wherein the action is at least one of: sending an alert to a supervisor, creating a log entry in a data store, sending an email, updating a performance rating associated with the identity of the client device, or including an entry in a report.

7. The system of claim 5, further comprising a gateway device in communication with the plurality of beacons over a wireless network, wherein the gateway device is in further communication with the at least one computing device over a second network, the gateway device being configured to facilitate communications between the plurality of beacons and the at least one computing device.

8. The system of claim 5, wherein the first geofence corresponds to a first beacon of the plurality of beacons and a second beacon of the plurality of beacons.

9. The system of claim 8, wherein the first geofence is a region where a range of the first beacon overlaps with a range of the second beacon.

10. The system of claim 8, wherein the first geofence is a region that includes a range of the first beacon and a range of the second beacon.

11. The system of claim 5, wherein the first task corresponds to at least one activity which requires the client device to be present within the first geofence for a required duration.

12. The system of claim 5, wherein the at least one computing device is further configured to determine a second duration the client device was within the first geofence.

13. The system of claim 11, wherein the at least one computing device is further configured to execute the action upon determining that a sum of the first duration and the second duration does not meet the predetermined criteria associated with the first task.

14. A method comprising:
detecting that a client device entered within a first geofence corresponding to at least one of a plurality of beacons;
selecting a first task to be completed at the first geofence by the client device, the first task corresponding to a first duration;
detecting that the client device entered within a second geofence corresponding to at least a second one of the plurality of beacons;
selecting a second task to be completed at the second geofence by the client device, the second task corresponding to a second duration; and
executing an action upon determining that the client device completed at least one of: the first task or the second task.

15. The method of claim 13, wherein determining that the client device completed the first task further comprises determining that the client device was within the first geofence for a duration greater than the first duration.

16. The method of claim 15, wherein determining that the client device completed the second task further comprises determining that the client device was within the second geofence for a duration greater than the second duration.

17. The method of claim 16, wherein the action is executed upon determining that the client device completed the first task and the second task.

18. The method of claim 13, further comprising executing a different action upon determining that the client device did not complete at least one of: the first task or the second task.

19. The method of claim 13, wherein the first geofence surrounds a vicinity of at least one piece of equipment.

20. The method of claim 19, wherein selecting the first task is based at least in part on the at least one piece of equipment and a role of an account associated with the client device.
